(19) United States
(12) Patent Application Publication
(10) Pub. No.: US 2013/0164034 A1
(43) Pub. Date: Jun. 27, 2013

(54) PASSIVE BELT STEERING APPARATUS AND SYSTEMS

(71) Applicant: David Kenneth AHL, Rochester, NY (US)

(72) Inventor: David Kenneth AHL, Rochester, NY (US)

(73) Assignee: XEROX CORPORATION, Norwalk, CT (US)

(21) Appl. No.: 13/336,556

(22) Filed: Dec. 23, 2011

(51) Int. Cl. G03G 15/00; G03G 15/20; B65G 39/16; G03G 15/16

(52) U.S. Cl. 399/165; 399/313; 198/806; 399/329

(57) ABSTRACT

A passive belt steering apparatus includes a steering linkage at two ends of a steering roll. The steering linkage includes a fixed support and a steering link movably connected to the fixed support and a steering roll at to pivot points. The two pivot points are offset from one another to accommodate passive hard axis roll alignment in response to an axial force to the steering roll applied by a misaligned or incorrectly positioned belt.

### FIELD OF DISCLOSURE

The disclosure relates to apparatus and systems for maintaining belt alignment in a printing system. In particular, the disclosure relates to apparatus and systems for passively and automatically steering a belt to prevent and/or remedy belt misalignment.

### BACKGROUND

In printing systems, belts such as transfer belts, fuser belts and photoreceptor belts may be, for example, endless belts that are entrained about rolls and/or other structural members that facilitate support and/or translation of the belt. During operation, a belt may “walk,” or move to one side or another of a belt path as the belt translates forward or backward in a process direction. Conventional methods of preventing walking include imposing large forces on belt edges, which may lead to belt deterioration including tearing, wear on printing system components, and a decrease in the useful life of the belt. Active steering mechanisms may be used to counteract belt walking, but such systems require sensors, motors or similar devices to alter roll alignments and logic circuits, which are complex and costly to manufacture, maintain, and control.

### SUMMARY

Passive steering apparatus and systems for belt systems are provided that accommodate passive steering correction without requiring complex software and sensors. Passive steering apparatus and systems may be implemented in printing systems, for example, and may include photoreceptor belts in monochrome machines, transfer belts, and fuser belts. Passive belt steering apparatus and systems in accordance with embodiments may accommodate reduced system costs compared with active steering mechanisms, improved reliability, reduced belt costs, reduced belt wear and increased belt life, and lower system failure rates.

An embodiment of apparatus may include a steering linkage for supporting a steering roll, the steering linkage comprising a steering linkage support; and a steering link, the steering link being configured for pivotal connection to the steering linkage support structure at a first end of the steering link, the steering link being configured for pivotal connection to the steering roll at a second end of the steering link, wherein a first pivot point at which the steering link pivotally connects to the steering roll is laterally offset from a second pivot point at which the steering link connects to the steering linkage support.

In an embodiment, a belt steering apparatus may include a steering roll, the steering roll having a first end and a second end, with respect to a rotational axis of the steering roll. The belt steering apparatus may include a transfer belt, the belt being entrained about one or more rolls, the one or more rolls including the steering roll. The belt steering apparatus may include a drive roll, the drive roll configured for driving the belt for rotation of the belt around the steering roll and the drive roll.

In an embodiment, a belt steering apparatus may include a photoreceptor belt, the belt being entrained about one or more rolls, the one or more rolls including the steering roll. In an embodiment, a belt steering apparatus may include a fuser belt, the belt being entrained about one or more rolls, the one or more rolls including the steering roll. In an embodiment, a belt steering apparatus may include a transfer roll, the transfer roll configured for defining an image transfer nip.

In an embodiment, a steering roll may include a first flange formed on the first end of the steering roll; and a second flange formed on the second end of the steering roll, the first flange and the second flange being configured to center a belt on the steering roll. In an embodiment, the steering roll may include the first end of the steering roll and the second end of the steering roll being tapered to center a belt on the steering roll.

In an embodiment, a steering roll may include a first end of the steering roll and a second end of the steering roll having fixed, non-rotating edge guides arranged and configured to center a belt on the steering roll. The fixed, non-rotating edges may extend from a steering linkage, for example.

An embodiment of passive belt steering system may include a steering roll for steering a belt, the steering roll having a first end and a second end; a first steering linkage for supporting the steering roll by the first end; and a second steering linkage for supporting the steering roll by the second end, the first steering linkage and the second steering linkage being configured for enabling axial and radial movement by the steering member. In embodiment, systems may include a transfer roll for transferring a marking material image; a transfer belt, the transfer belt being entrained by the steering roll and the transfer roll, and the transfer belt having an image carrying surface.

In an embodiment, systems may include a backup roll, the backup roll defining a nip with the transfer roll, the belt interposing the backup roll and the transfer roll. In an embodiment, system may include a sheet transport for carrying a sheet, the sheet transport being configured to pass the sheet through nip defined by the transfer roll and the backup roll for transferring an image from the transfer belt to the sheet. In an embodiment, the first and second steering linkages may each include a steering linkage support; and a steering link, the steering link being configured for pivotal connection to the steering linkage support structure at a first end of the steering link, the steering link being configured for pivotal connection to the steering roll at a second end of the steering link, wherein a first pivot point at which the steering link pivotally connects to the steering roll is laterally offset from a second pivot point at which the steering link connects to the steering linkage support.

In an embodiment, the steering roll may include a first flange formed on the first end of the steering roll; and a second flange formed on the second end of the steering roll, the first flange and the second flange being configured to center a belt on the steering roll. In an embodiment, systems may include the steering roll further comprising the first end of the steering roll and the second end of the steering roll being tapered to center a belt on the steering roll. In an embodiment, systems may include the steering roll further comprising the first end of the steering roll and the second end of the steering roll having fixed, non-rotating edge guides may be arranged and configured to center a belt on the steering roll.

Exemplary embodiments are described herein. It is envisioned, however, that any systems that incorporate features of methods and systems described herein are encompassed by the scope and spirit of the exemplary embodiments.

### BRIEF DESCRIPTION OF THE DRAWINGS

FIG. 1 shows a belt apparatus in a printing system;

FIG. 2 shows a side diagrammatical view of a belt steering apparatus in accordance with an exemplary embodiment;

FIG. 3 shows a top diagrammatical view of a belt steering apparatus in accordance with an exemplary embodiment;

FIG. 4 shows a top diagrammatical view of the belt steering apparatus in accordance with an exemplary embodiment.

### DETAILED DESCRIPTION

Exemplary embodiments are intended to cover all alternatives, modifications, and equivalents as may be included within the spirit and scope of the methods, apparatus, and systems as described herein.

Reference is made to the drawings to accommodate understanding of passive belt steering apparatus and systems. In the drawings, like reference numerals are used throughout to designate similar or identical elements. The drawings depict various embodiments of illustrative passive belt steering apparatus and systems.

Passive belt steering apparatus may be implemented in systems that require belt alignment during operation to counteract belt misalignment, including misalignment known as “belt walking.” Belt walking may result from, for example, imperfect alignment of supporting rolls, and/or forces from printing system components. Belt walking is a form of soft misalignment, and related art steering mechanism incorporate methods of soft realignment that are complex, costly, inefficient, and result in belt wear.

Passive belt steering apparatus and systems in accordance with embodiments, however, use soft and hard axis roll alignment to provide a tracking force to counteract forces resulting from misalignment. In particular, passive belt steering apparatus may include a steering roll about which a belt may be entrained. The belt may be a photoreceptor belt configured for implementation in monochrome printing systems, may be a transfer belt for image transfer, or may be a fuser belt for fusing an image to a substrate in a printing system.

The steering roll may be rotatably mounted, and connected to at least one steering linkage at a first or second end of the steering roll. The steering linkage may be configured to connect the steering roll to a structure, such as a frame, for support. The steering linkage may be configured to increase or decrease belt tension to counteract misalignment forces, creating a tracking force in a direction that is opposite to, e.g., a direction in which the belt is walking. The steering linkage may be configured to counteract roll misalignment by allowing movement of the steering roll in a direction having components of both axial and radial directions of movement, with respect to rotational axis of the belt.

For example, a steering linkage may be pivotable for allowing both soft and hard axis alignment of the steering roll. The steering linkage may include a first pivot point and a second pivot point. The first pivot point and the second pivot point may be connected by a steering link. One pivot point may be located on a portion of the steering linkage that is fixedly connected to a belt apparatus frame or other structure adjacent to a first or second end of the steering roll. The other pivot point may be located on the first or second end of the steering roll. For example, the second pivot point may be located on a bearing and/or associated mounting structure configured for holding the steering roll at the first or second end. The first pivot point and the second pivot point may be arranged so that they are offset from one another, such that axial movement of the steering roll causes a movement of the steering link that causes a radial movement of the steering roll with respect to its rotational axis, thus creating a steering force on the belt in the opposite direction of the movement of the steering link and roll.

A steering linkage may be located at both a first end and a second end of a steering roll in a passive belt steering belt apparatus. Each of a first steering link and a second steering link located at respective first and second ends of a steering roll may include a steering link attached to a first pivot point and a second pivot point of the linkage. The first pivot point and the second pivot point may be positioned to accommodate movement of the steering roll in a direction having both axial and radial components, with respect to a rotational axis of the steering roll. Accordingly, the steering linkage may accommodate steering roll movement in a direction having both axial and radial components, with respect to the rotational axis of the steering member.

A steering linkage in passive steering apparatus and systems having a first pivot point that connects a steering link to a first fixed steering member portion and a second pivot point that connects the steering link to the steering roll may include an offset between the first and second pivot points.

Accordingly, as the belt walks axially in a first direction exerting a force on the steering roll, the roll may follow the belt movement, thereby causing the steering link of the steering linkage to move. The steering link movement may cause the roll to move in a direction having both radial and axial components, with respect to an axis of rotation of the steering roll, changing the hard axis alignment of the steering roll.

For example, as the steering roll moves axially in a first direction toward a first end of the steering roll to increase belt tension at the first end, an opposite second end of the steering roll moves in a direction that decreases belt tension at the second end. This provides a tracking force for moving the belt back toward the second direction. Conversely, if the steering roll tracks toward the second end, the steering linkage(s) may accommodate movement of the steering roll toward the first end. Accordingly, belt tracking may quickly and efficiently reach equilibrium during operation.

In another embodiment, one or more tracking guides may be configured on the steering roll. The tracking guide(s) may be configured to ensure that the belt remains at a desired location on the steering roll. For a rigid belt, such as a photoreceptor belt or a fuser belt, flanges may be formed on the steering roll. The flanges may be configured to apply a force to the belt as the belt moves toward one of a first and a second end of the steering roll. The steering linkage and movable steering link enable minimal edge forces to be applied to belt edges by one or more flanges.

In an embodiment, a tracking guide may include tapering or crowning formed on a first and/or second end of the steering roll to direct the belt to a desired axial location (e.g. centered) with respect to the roll. The crowning and/or tapering may be suitable for more flexible belts such as a transfer belt, where the application of edge forces adequate to direct the belt is impractical. In an embodiment, the first end and/or second end of the steering roll may include one or more tracking guides having fixed or non-rotating edges that are configured to prevent movement of a belt beyond a particular region of the steering roll. For example, a rigid edge may be formed on a member extending from a steering linkage, and may be configured to contact the walking belt. Similarly, in an embodiment, a first portion of a surface of the steering member may be coated or processed to have a different coefficient of friction than a second portion of the surface of the steering roll. The steering linkage allows minimal edge forces to be imposed on the belt by such tracking guides because the linkage allows free axial movement of the roll.

Printing systems having passive belt steering in accordance with an embodiment may include a belt transfer apparatus having a belt entrained about at least one roll, the steering roll. In an embodiment, the belt transfer apparatus may include a steering roll, and a transfer roll. In another embodiment, the belt apparatus may include a drive roll that is configured to drive the belt. The belt transfer apparatus may be configured in the printing system so that the transfer roll forms a nip with a backup roll, the transfer belt being entrained about the steering roll and the transfer roll, and passing through the transfer nip. At the transfer nip, a toner or ink image may be transferred from the transfer belt. In an embodiment, a photoreceptor assembly, which may include a photoreceptor belt, may be configured to contact the transfer belt. For example, the photoreceptor belt may be configured to pass through the transfer nip along with the transfer belt.

A steering roll of the belt transfer apparatus may be configured to automatically counteract soft-axis misalignment, lateral movement, or, with respect to a rotational axis of the steering roll, axial misalignment of the steering roll. In particular, the steering roll may be connected to a structural support by way of a movable steering linkage that is configured to allow the steering roll to move in a direction having components in both the axial and radial direction, with respect to the rotational axis. The movable steering linkage may include, for example, two pivot points that are offset from one another. A steering linkage support and steering link may be connected at one pivot point, and the steering link and the steering roll may be connected at another pivot point, and configured to allow movement in response to belt force. With respect to the axis of rotation, the two pivot points may be spaced apart to form an offset that creates a radial movement of the steering roll. The steering linkage may be included at both a first end and a second end of the steering roll. The passive belt steering apparatus may be implemented in a printing system for steering a fuser belt, a photoreceptor belt, and/or an image transfer belt, for example.

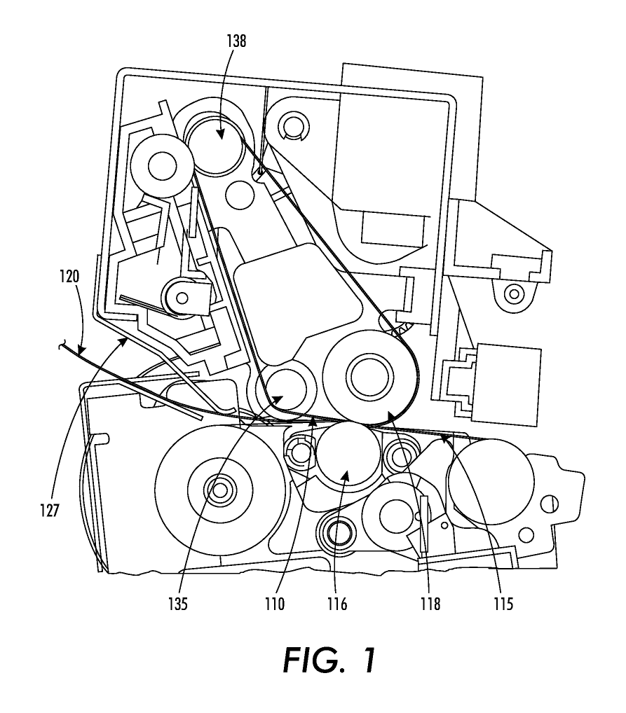

FIG. 1 shows a printing system having a belt transfer apparatus. The printing system shown in FIG. 1 includes a belt transfer apparatus having a transfer belt 110. The belt transfer apparatus may be configured in a printing system such as the system shown in FIG. 1 wherein the transfer belt 110 contacts a photoreceptor member such as a photoreceptor belt 115.

The belt 110 may be entrained about a transfer roll 118, and the transfer roll 118 may be configured to define a transfer nip with a back up roll 120 when the belt transfer apparatus is in an operating position within the printing system. The transfer belt 110 may pass through the transfer nip. The photoreceptor belt 115 may pass through the transfer nip, and may contact the transfer belt 110.

A sheet 121 may be inserted in an inlet of the printing system, guided by a baffle 127. The sheet 121 may pass through the transfer nip for transfer of an image from the transfer belt to the sheet. The image may be formed of marking material such as ink or toner.

The transfer belt 110 may also be entrained about an inlet roll 135, which may contact the sheet 121 before the sheet enters the transfer nip during a print operation. The belt 110 may also be entrained about a steering roll 138. The belt 110 may be formed of isoprene, neoprene, or other suitable material of controlled electrical resistivity.

During operation, as the transfer belt 110 moves around the steering roll 138, the belt may become misaligned toward either axial end of the steering roll 138. For example, the belt 110 may migrate laterally toward the printing system frame. To counteract such misalignment, the belt transfer apparatus may be configured to accommodate automatic passive steering (not shown). For example, the steering roll 138 may be attached at either end to a frame or other structural support by way of a steering linkage (not shown), which may accommodate axial and radial movement of the steering member. The steering linkage may include a first pivot point attached to either end of the steering roll 138, a steering link connected at the first pivot point and extending to a connection at a second pivot point to a fixed linkage portion connected to the frame of the belt apparatus or printing system. The pivot points may be axially offset from one another wherein their locations correspond to two different points on a line running substantially perpendicular to a longitudinal or rotational axis of the steering roll 138.

A steering linkage may be arranged at both ends of the steering roll 138. Accordingly, as the belt 110 migrates to either end of the steering roll 138, the steering roll 138 will follow, causing the links to pivot laterally toward a side of the printing system or transfer apparatus frame. The movable steering link and its offset pivot points enables lateral and radial movement of the steering links and also hard axis roll alignment.

Printing systems having passive belt steering in accordance with an embodiment may include a belt transfer apparatus having a belt entrained about at least one roll, the steering roll. A belt transfer apparatus may be configured for fusing or image transfer, for example. The belt may be a transfer belt, photoreceptor belt, or a fuser belt, for example. A steering roll of the belt transfer apparatus may be configured to automatically counteract soft-axis misalignment, lateral movement, or, with respect to a rotational axis of the steering member, axial misalignment of the steering roll. In particular, the steering member may be connected to a structural support by way of a movable steering linkage that is configured to allow the steering roll to move in a direction having components in both the axial and radial direction, with respect to the rotational axis.

The movable steering linkage may include, for example, two pivot points that are offset from one another. A steering linkage support and steering link may be connected at one pivot point, and the steering link and the steering roll may be connected at another pivot point, and configured to allow movement in response to belt force. With respect to the axis of rotation, the two pivot points may be spaced apart to form an offset that causes radial movement of the steering roll. The steering linkage may be included at both a first end and a second end of the steering roll. In an embodiment, a passive belt steering apparatus may be implemented in, for example, a printing system such as the printing system shown in FIG. 1.

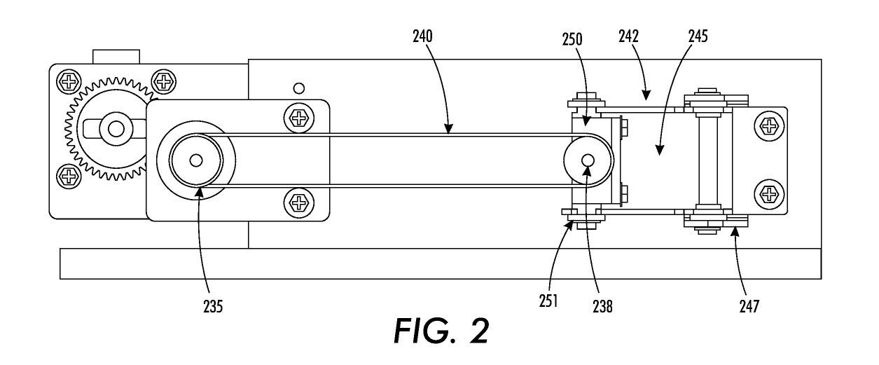

FIG. 2 shows a side view of a passive belt steering apparatus having a steering linkage with offset pivots points in accordance with an embodiment. In particular, FIG. 2 shows a drive roll 235 and a steering roll 238 entraining a transfer belt 240. The drive roll 235 may be associated with a motor, and configured to drive the belt 240 and the steering roll 238.

The steering roll 238 may be connected to a steering linkage 242. The steering roll 238 may be connected to the steering linkage 242 at an end of the steering roll using a suitable mounting structure, which may include, for example, a bearing arrangement. The bearing arrangement may include a bearing block 250 that holds the bearings that mount and locate the steering roll. Bearing block 250 may be mounted in bushings 251, allowing the steering roll bearings to pivot with respect to the steering linkage.

The mounting structure or other portion of the steering linkage 242 that connects the steering linkage 242 to the steering roll 238 may be attached to a steering link 245. The steering link 245 may be configured so that it is movably attached to the steering linkage support 247. For example, the steering link 242 may be attached to the steering linkage support 247 at a pivot point. The steering link 245 may be configured to pivot about the pivot point.

The steering linkage support 247 may be fixedly attached to a structural body such as side from of a passive belt steering apparatus or a system implementing a passive belt steering apparatus.

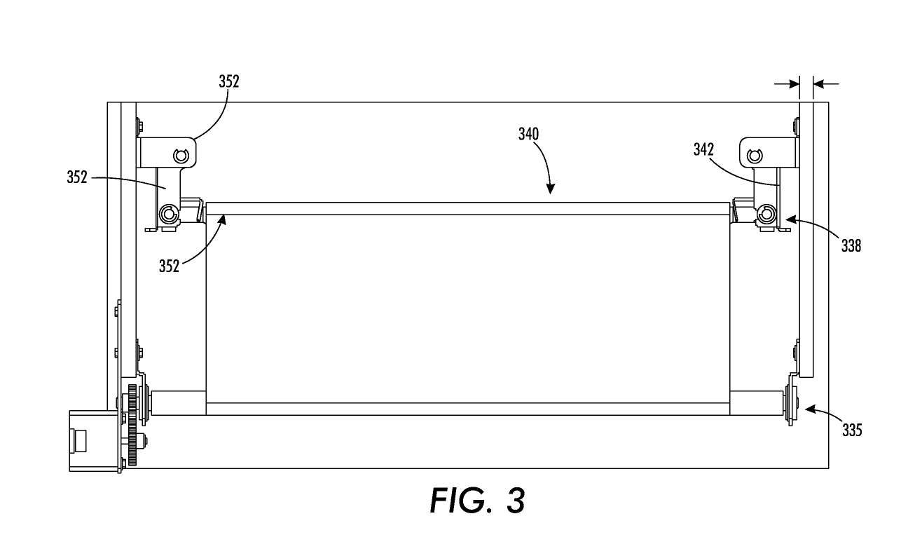

FIG. 3 shows a top diagrammatical view of a passive belt steering apparatus in accordance with an embodiment. Passive belt steering apparatus may include a drive roll 335, a steering roll 338, a transfer belt 340, and a steering linkage 342.

The steering linkage 342 may be attached to the steering roll 338 at a first pivot point. The steering linkage 342 may include a steering link 342 that is movably attached at the first pivot point at a first end thereof. A second end of the steering link 342 may be attached at a second pivot point on a steering linkage support 347. The steering linkage support 347 may be fixed to a side frame of a belt apparatus and/or system.

A position of the first pivot point may be offset axially by an offset 350 from a position of the second pivot point to allow lateral and hard-axis (radial) movement of the steering roll 338 in response to a force applied to the roll by the belt. The first pivot point may be arranged at a location that corresponds to a different point on a line that runs parallel to a longitudinal axis of the steering member 338 than the location of a second pivot point. Accordingly, the steering link 345 of the steering linkage 342 may move the steering member 338 in a direction having both axial and hard-axis (radial) components to counteract roll misalignment in response to a force applied to the steering roll 338 from the belt 340. As such, belt realignment is passive and automatic.

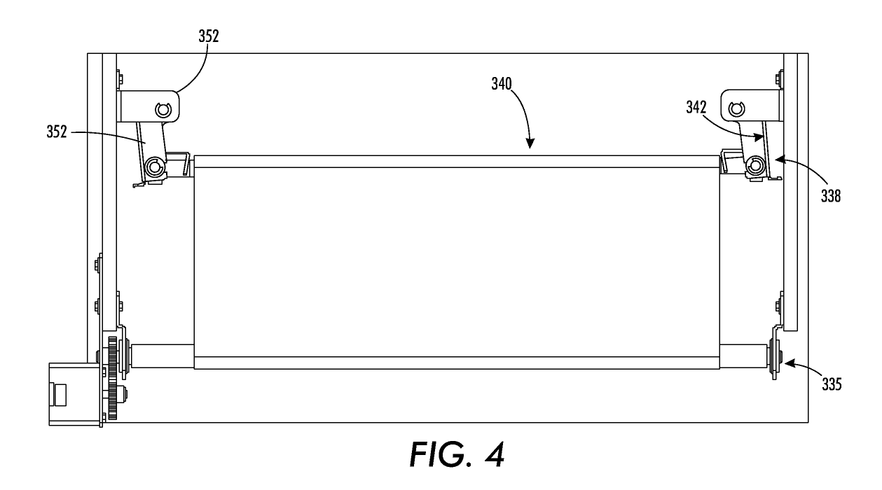

For example, while FIG. 3 shows the steering links 345 in a resting position, FIG. 4 shows the reaction the steering linkage 442 to force applied from the belt through the steering member 438. In particular, FIG. 4 shows a top diagrammatical view of a passive belt steering apparatus in accordance with an embodiment. Passive belt steering apparatus may include a drive roll 435, a steering roll 438, a transfer belt 440, and a steering linkage 442.

The steering linkage 442 may be attached to the steering roll 438 at a first pivot point. The steering linkage 442 may include a steering link 442 that is movable attached at the first pivot point at a first end thereof. A second end of the steering link 442 may be attached at a second pivot point on a steering linkage support 447. The steering linkage support 447 may be fixed to a side frame of a belt apparatus and/or system.

A position of the first pivot point may be offset by an offset 450 from a position of the second pivot point to allow lateral and hard-axis (radial) movement of the steering roll 438 in response to a force applied to the roll by the belt. The first pivot point may be arranged at a location that corresponds to a different point on a line that runs parallel to a longitudinal axis of the steering member 438 than the location of a second pivot point. Accordingly, the steering link 445 of the steering linkage 442 may move the steering member 438 in a direction having both axial and hard-axis (radial) components to counteract roll misalignment in response to a force applied to the steering roll 438 from the belt 440, as shown by the arrows depicting steering link movement. As such, belt realignment is passive and automatic.

While apparatus and systems are described in relationship to exemplary embodiments, many alternatives, modifications, and variations would be apparent to those skilled in the art. Accordingly, embodiments of methods, apparatus, and systems as set forth herein are intended to be illustrative, not limiting. There are changes that may be made without departing from the spirit and scope of the exemplary embodiments.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art.

What is claimed is:

1. A passive belt steering apparatus, comprising:
a steering linkage for supporting a steering roll, the steering linkage comprising:
a steering linkage support; and
a steering link, the steering link being configured for pivotal connection to the steering linkage support structure at a first end of the steering link, the steering link being configured for pivotal connection to the steering roll at a second end of the steering link, wherein a first pivot point at which the steering link pivotally connects to the steering roll is offset from a second pivot point at which the steering link connects to the steering linkage support.

2. The belt steering apparatus of claim 1, comprising:
a steering roll, the steering roll having a first end and a second end, with respect to a rotational axis of the steering roll.

3. The belt steering apparatus of claim 2, comprising:
a transfer belt, the belt being entrained about one or more rolls, the one or more rolls including the steering roll.

4. The belt steering apparatus of claim 3, comprising:
a drive roll, the drive roll configured for driving the belt for rotation of the belt around the steering roll and the drive roll.

5. The belt steering apparatus of claim 2, comprising:
a photoreceptor belt, the belt being entrained about one or more rolls, the one or more rolls including the steering roll.

6. The belt steering apparatus of claim 2, comprising:
a fuser belt, the belt being entrained about one or more rolls, the one or more rolls including the steering roll.

7. The belt steering apparatus of claim 3, comprising:
a transfer roll, the transfer roll configured for defining an image transfer nip.

8. The belt steering apparatus of claim 2, the steering roll further comprising:
a first flange formed on the first end of the steering roll; and
a second flange formed on the second end of the steering roll, the first flange and the second flange being configured to center a belt on the steering roll.

9. The belt steering apparatus of claim 2, the steering roll further comprising the first end of the steering roll and the second end of the steering roll being tapered to center a belt on the steering roll.

10. The belt steering apparatus of claim 2, the steering roll further comprising the first end of the steering roll and the second end of the steering roll having fixed, non-rotating edge guides may be arranged and configured to center a belt on the steering roll.

11. A passive belt steering system, comprising:
a steering roll for steering a belt, the steering roll having a first end and a second end;
a first steering linkage for supporting the steering roll by the first end; and
a second steering linkage for supporting the steering roll by the second end, the first steering linkage and the second steering linkage being configured for enabling axial and radial movement by the steering member.

12. The system of claim 11, comprising:
a transfer roll for transferring a marking material image;
a transfer belt, the transfer belt being entrained by the steering roll and the transfer roll, and the transfer belt having an image carrying surface.

13. The system of claim 12, comprising:
a backup roll, the backup roll defining a nip with the transfer roll, the belt interposing the backup roll and the transfer roll.

14. The system of claim 13, comprising:
a sheet transport for carrying a sheet, the sheet transport being configured to pass the sheet through nip defined by the transfer roll and the backup roll for transferring an image from the transfer belt to the sheet.

15. The system of claim 11, the first steering linkage and the second steering linkage each further comprising:
a steering linkage support; and
a steering link, the steering link being configured for pivotal connection to the steering linkage support structure at a first end of the steering link, the steering link being configured for pivotal connection to the steering roll at a second end of the steering link, wherein a first pivot point at which the steering link pivotally connects to the steering roll is offset from a second pivot point at which the steering link connects to the steering linkage support.

16. The system of claim 11, the steering roll further comprising:
a first flange formed on the first end of the steering roll; and
a second flange formed on the second end of the steering roll, the first flange and the second flange being configured to center a belt on the steering roll.

17. The system of claim 11, the steering roll further comprising the first end of the steering roll and the second end of the steering roll being tapered to center a belt on the steering roll.

18. The system of claim 11, the steering roll further comprising
the first end of the steering roll and the second end of the steering roll having fixed, non-rotating edge guides may be arranged and configured to center a belt on the steering roll.
